(19) United States
(12) Patent Application Publication
(10) Pub. No.: US 2026/0217092 A1
(43) Pub. Date: Jul. 30, 2026

(54) VEHICLE OUTER PANEL ASSEMBLY

(71) Applicant: TOYOTA JIDOSHA KABUSHIKI KAISHA, Aichi-ken (JP)

(72) Inventor: Hiroki HYODO, Toyota-shi (JP)

(21) Appl. No.: 19/378,333

(22) Filed: Nov. 4, 2025

(30) Foreign Application Priority Data
Jan. 30, 2025 (JP) 2025-014099

(51) Int. Cl. B60J 5/04

(52) U.S. Cl. CPC B60J 5/0415; B60J 5/0463; B60J 5/048

(57) ABSTRACT

A front door comprising a metal door frame and a resin door outer panel whose outer peripheral portion is attached to the vehicle outer side of the door frame, wherein the outer peripheral portion is slidable with respect to the door frame by a length shorter than a difference between an amount of thermal expansion of the door outer panel and an amount of thermal expansion of the door frame.

### CROSS REFERENCE TO RELATED APPLICATION

This application claims priority to Japanese Patent Application No. 2025-014099 filed on Jan. 30, 2025, which is incorporated herein by reference in its entirety including the specification, claims, drawings, and abstract.

### TECHNICAL FIELD

The present disclosure relates to a vehicle outer panel assembly including a metal frame and a resin outer panel.

### BACKGROUND

JP2015-9799A discloses a vehicle member composed of an inner panel of a carbon fiber reinforced plastic and an outer panel of aluminum having a larger linear expansion coefficient than that of the carbon fiber reinforced plastic. In the vehicle member, a thermal expansion absorbing portion that absorbs a thermal expansion difference between the inner panel and the outer panel is provided in the inner panel.

### SUMMARY

In recent years, a vehicle outer panel assembly including a metal frame and a resin outer panel has been used. Since the expansion amount of the resin outer panel is larger than the thermal expansion amount of the metal frame, the panel end of the outer panel extends outward due to thermal expansion. Therefore, it is necessary to increase the gap between the adjacent components, and the appearance may be deteriorated.

An object of the present disclosure is to suppress outward extension of a panel end of an outer panel due to thermal expansion in a vehicle outer panel assembly including a metal frame and a resin outer panel.

A vehicle outer panel assembly according to an embodiment of the present disclosure includes: a frame made of metal; and a resin outer panel having an outer peripheral portion attached to a vehicle outer side of the frame. The outer peripheral portion is slidable with respect to the frame by a length shorter than the difference between an amount of thermal expansion of the outer panel and an amount of thermal expansion of the frame.

Accordingly, the amount of movement of the outer panel to the outside of the panel end when the outside air temperature rises can be reduced, and the appearance can be improved.

In the vehicle outer panel assembly according to the present disclosure, the outer peripheral portion includes a first peripheral segment fixed to the frame and a second peripheral segment opposite to the first peripheral segment. The second peripheral segment may be slidably attached to the frame by a length shorter than the difference between an amount of thermal expansion of the outer panel between the first peripheral segment and the second peripheral segment and an amount of thermal expansion of the frame between the first peripheral segment and the second peripheral segment.

As a result, the amount of movement of the first peripheral segment to the outside can be made substantially zero, and the amount of movement of the second peripheral segment to the outside when the outside air temperature rises can be reduced, thereby improving the appearance.

In the vehicle outer panel assembly of the present disclosure, the outer peripheral portion further includes a third peripheral segment extending between the first peripheral segment and the second peripheral segment. The third peripheral segment may be attached to the frame so as to be slidable in the same direction as the second peripheral segment with respect to the frame and so as to restrict movement of the second peripheral segment in a direction orthogonal to the sliding direction.

In this way, by making the third peripheral segment slidable together with the second peripheral segment, it is possible to reduce the thermal stress of the outer panel when the outside air temperature rises. In addition, it is possible to improve the appearance by reducing the amount of movement of the third peripheral segment to the outside when the outside air temperature rises.

In the vehicle outer panel assembly according to the present disclosure, the third outer peripheral segment may be adjacent to a member arranged next to the outer panel, and a direction orthogonal to a sliding direction of the second peripheral segment may be a direction intersecting a boundary line with the member.

Thus, the gap between the third peripheral segment and the member can be reduced to improve appearance.

In the vehicle outer panel assembly of the present disclosure, the frame and the outer panel may constitute a side door of a vehicle. The first peripheral segment may be an upper peripheral segment of the outer panel located near a beltline of the side door. The second peripheral segment may be a lower peripheral segment of the outer panel. The third peripheral segment may be a front peripheral segment or a rear peripheral segment of the outer panel.

The movement amount of the upper peripheral segment in the vicinity of the belt line of the side door when the outside air temperature rises can be substantially zero. Further, the amount of forward movement of the front peripheral segment or the amount of rearward movement of the rear peripheral segment when the outside air temperature rises can be substantially zero. Thus, appearance can be improved. Further, since the lower peripheral segment is movable in the downward direction, it is possible to reduce the thermal stress of the outer panel when the outside air temperature rises.

In the vehicle outer panel assembly of the present disclosure, the outer panel includes an interior portion other than the outer peripheral portion, a vehicle inner side surface of the interior portion is supported by the frame so as to be movable in the plate thickness direction

Accordingly, the interior portion can move in the plate thickness direction to absorb the thermal expansion of the outer panel, and the outer panel can be prevented from fluttering.

According to the present disclosure, in the vehicle outer panel assembly including the metal frame and the resin outer panel, it is possible to suppress outward extension of a panel end of the outer panel due to thermal expansion.

### BRIEF DESCRIPTION OF DRAWINGS

FIG. 1 is a side view of a vehicle including a front door according to an embodiment;

FIG. 2 is a perspective view of a front door according to the embodiment;

FIG. 3 is an elevation view of the front door shown in FIG. 2 as viewed from the vehicle inner side;

FIG. 4 is a cross-sectional view of the front door shown in FIG. 2, taken along line A-A of FIG. 3;

FIG. 5 is a cross-sectional view of the front door shown in FIG. 2, and is a cross-sectional view taken along line B-B shown in FIG. 3;

FIG. 6 is a detail of a portion C shown in FIG. 4;

FIG. 7 is a cross-sectional view of the elongated hole of the front peripheral segment and the clip taken along line F-F of FIG. 6;

FIG. 8 is a detail of a portion D shown in FIG. 5;

FIG. 9 is a cross-sectional view of the circular hole and the bolt of the upper peripheral segment taken along line G-G in FIG. 8;

FIG. 10 is a detail of a portion E shown in FIG. 5;

FIG. 11 is a cross-sectional view of the clip and the elongated hole of the lower peripheral segment taken along line H-H of FIG. 10.

### DESCRIPTION OF EMBODIMENTS

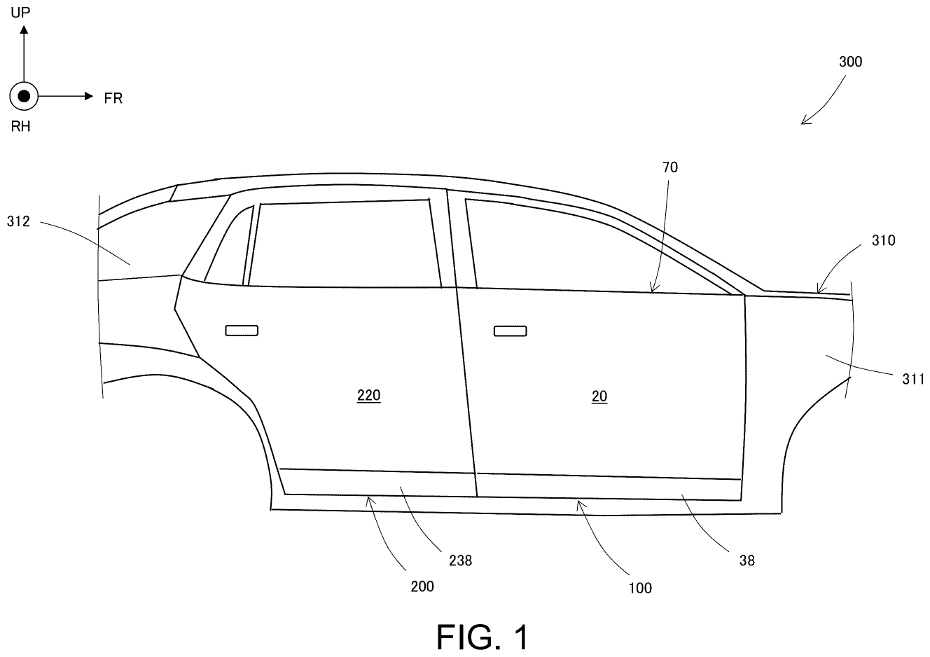

Hereinafter, the vehicle outer panel assembly according to an embodiment will be described with reference to the drawings. First, a vehicle 300 including a vehicle outer panel assembly according to an embodiment will be described with reference to FIG. 1. Note that FR, UP, and RH shown in the drawings indicate the front side, the upper side, and the right side of the vehicle 300, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of vehicle 300 are indicated unless otherwise specified.

The vehicle 300 includes a body 310, a front door 100, and a rear door 200. The body 310 is configured by attaching body outer panels such as a fender panel 311 and a quarter panel 312 to the outside of a body frame (not shown). The body frame is made of metal, and the fender panel 311 and the quarter panel 312 are made of resin. The front door 100 and the rear door 200 are side doors having front end portions rotatably attached to the body frame by hinges and rear end portions opened and closed toward the side of the vehicle 300. The front door 100, the rear door 200, the body frame and the fender panel 311, and the body frame and the quarter panel 312 are examples of a vehicle outer panel assembly. Hereinafter, the front door 100 will be described.

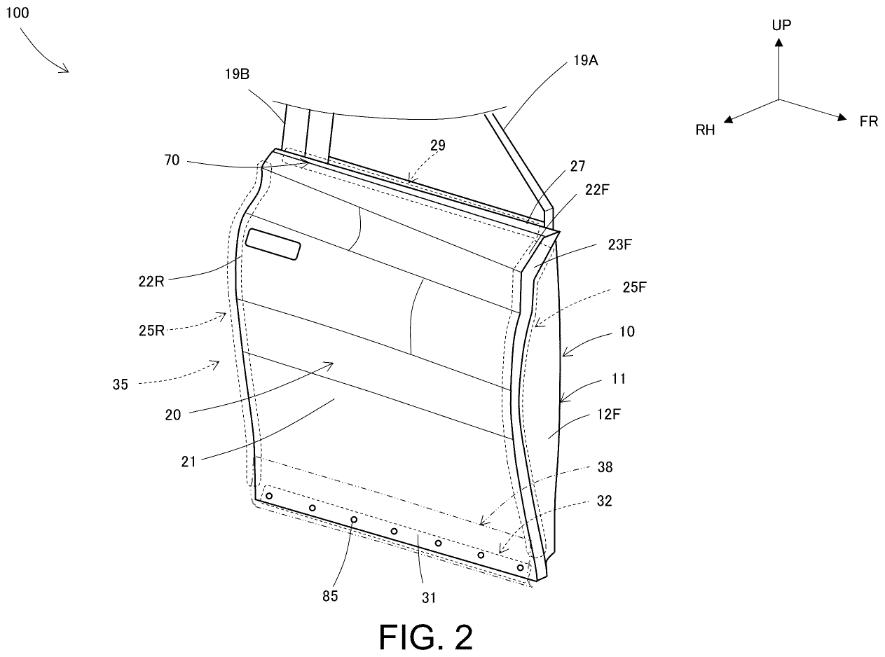

As shown in FIG. 2, the front door 100 includes a door frame 10, a door outer panel 20 attached to the outside of the door frame 10, and a lower garnish 38. The door frame 10 is made of metal, and the door outer panel 20 is made of resin.

As shown in FIGS. 2 to 5, the door frame 10 includes a door inner panel 11, window frames 19A and 19B, an outer reinforcement 16, a dent reinforcement 17, and an impact beam 18. The door inner panel 11, the window frames 19A and 19B, the outer reinforcement 16, the dent reinforcement 17, and the impact beam 18 are all made of metal.

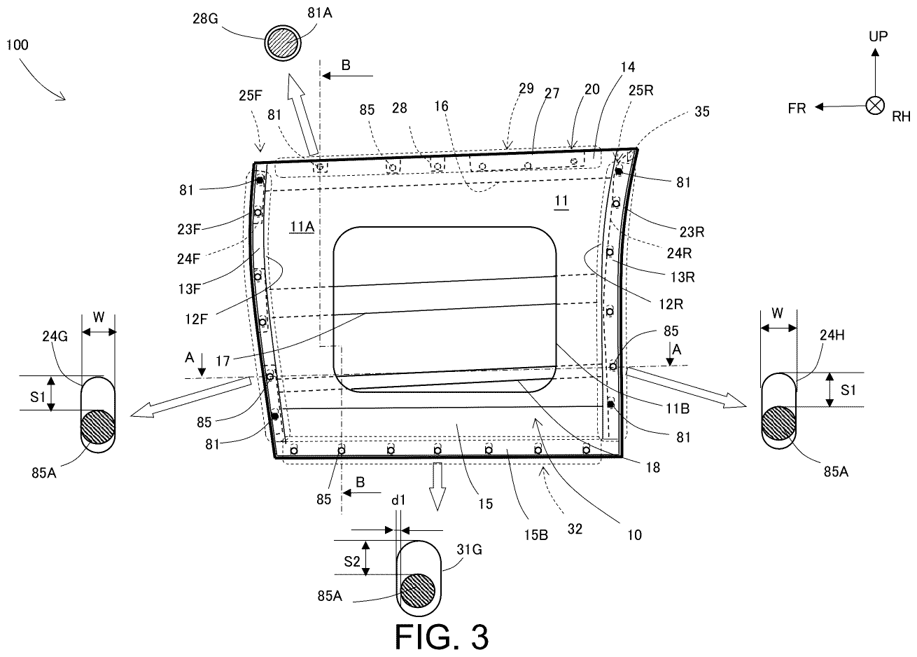

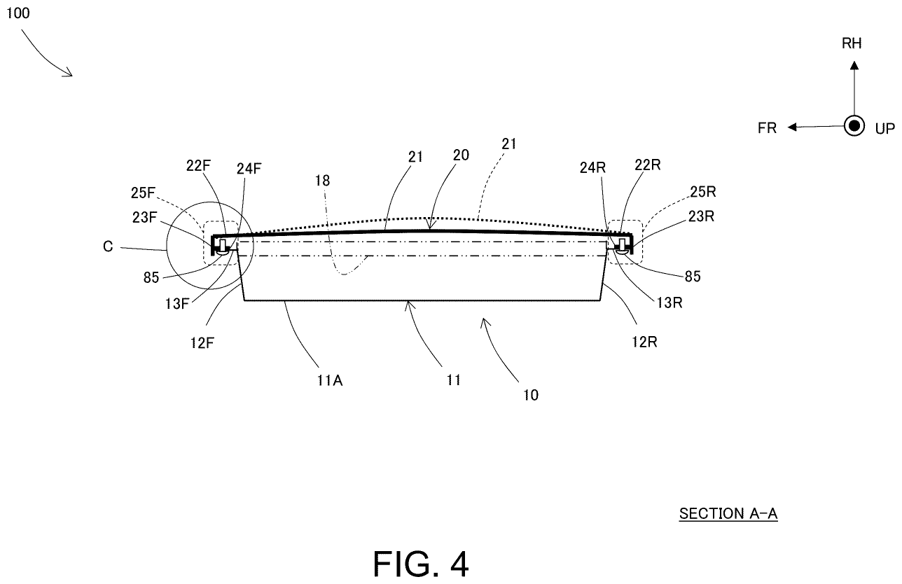

As shown in FIGS. 3 to 5, the door inner panel 11 includes an inner flat plate portion 11A, a front rising portion 12F, a rear rising portion 12R, a front flange 13F, a rear flange 13R, an upper rising portion 14, a lower rising portion 15, and a lower flange 15B. As shown in FIG. 3, the inner flat plate portion 11A is a metal flat plate portion in which a square opening 11B is provided in the center. As shown in FIGS. 3 and 4, the front rising portion 12F is a plate-like portion rising from the front edge of the inner flat plate portion 11A toward the vehicle outer side (right direction). The front flange 13F is a plate-like portion extending forward from a vehicle outer end (right end) of the front rising portion 12F. Similarly, the rear rising portion 12R is a plate-like portion rising from the rear edge of the inner flat plate portion 11A toward the vehicle outer side (right direction), and the rear flange 13R is a plate-like portion extending rearward from the vehicle outer end (right end) of the front rising portion 12F.

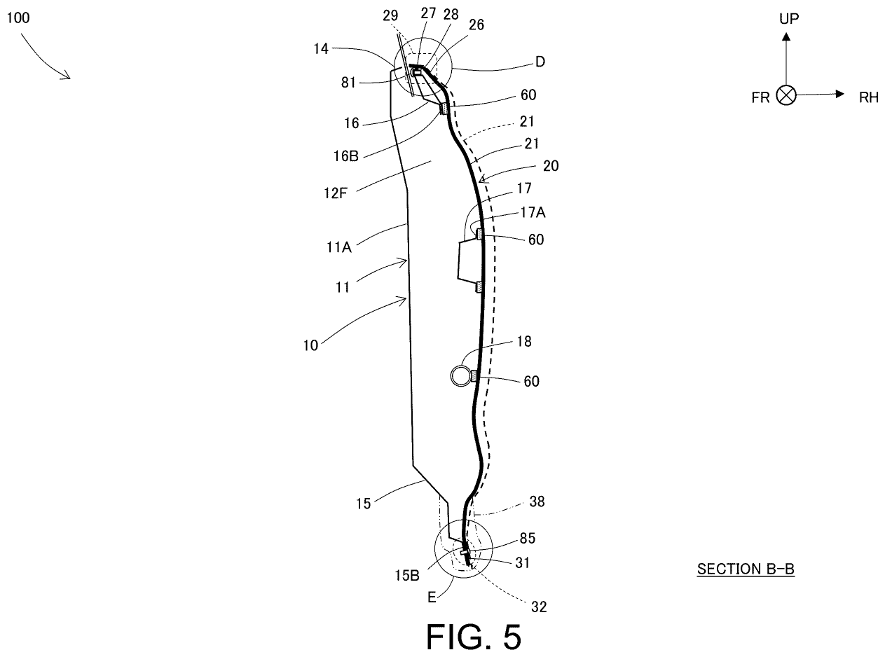

As shown in FIGS. 3 and 5, the upper rising portion 14 is a plate-like portion rising from the upper edge of the inner flat plate portion 11A toward the vehicle outer side (right direction), and the lower rising portion 15 is a folded plate-like portion rising from the lower portion of the inner flat plate portion 11A toward the vehicle outer side (right direction) in a stepwise manner. The lower flange 15B is a plate-like portion extending downward from the lower end of the lower rising portion 15.

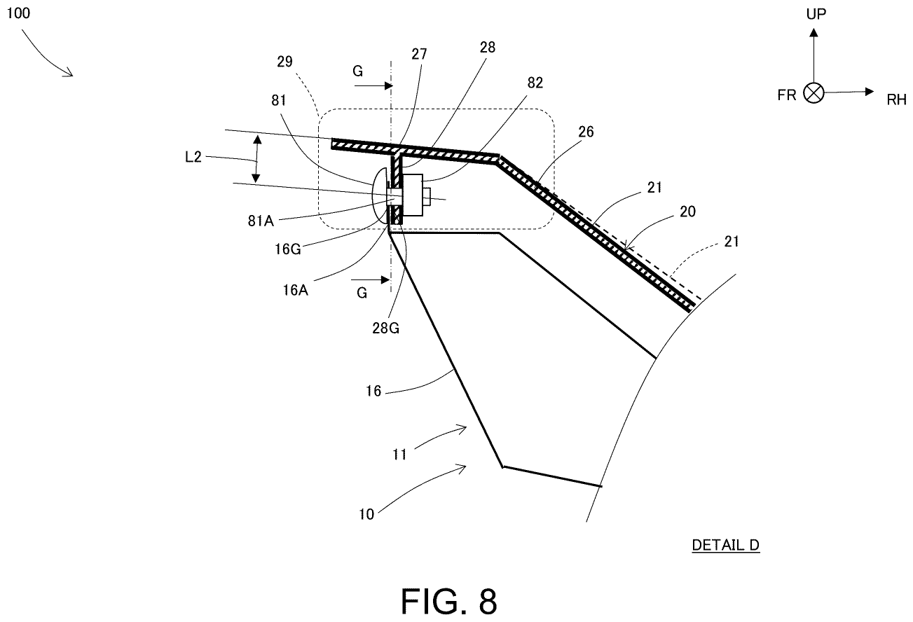

As shown in FIGS. 3 to 5, the outer reinforcement 16 is a longitudinal member that connects an upper portion of the front rising portion 12F and an upper portion of the rear rising portion 12R, which are opposed to each other in the front-rear direction, to each other in the front-rear direction. The outer reinforcement 16 has a closed cross-sectional structure and includes an upper arm 16A (see FIG. 8) extending upward and a lower arm 16B extending downward. The dent reinforcement 17 is a longitudinal member that connects a central portion of the front rising portion 12F in the up-down direction and a central portion of the rear rising portion 12R in the up-down direction to each other in the front-rear direction. The dent reinforcement 17 has a hat-shaped cross section in which the vehicle outer side (right side) is released. The impact beam 18 is a longitudinal member that connects the front rising portion 12F and the rear rising portion 12R in the front-rear direction below the dent reinforcement 17. The impact beam 18 has a cylindrical cross-Sectional shape.

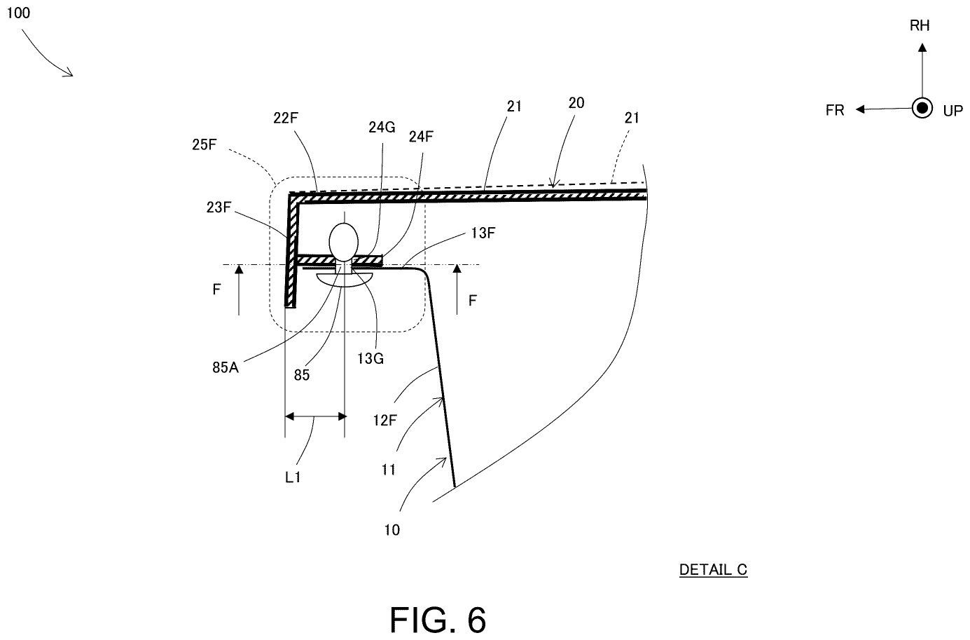

The front flange 13F, the rear flange 13R, and the lower flange 15B of the door inner panel 11 and the upper arm 16A of the outer reinforcement 16 are joined to the door outer panel 20 by bolts 81 or clips 85. Therefore, as shown in FIGS. 6 to 11, bolt holes 13G, 15G, and 16G through which the bolt 81 or the clip 85 passes are provided in the front flange 13F, the lower flange 15B, and the upper arm 16A of the outer reinforcement 16 of the door inner panel 11. Similarly to the front flange 13F, the rear flange 13R is provided with bolt holes 13G. The pitch of the bolt holes 13G, 15G, and 16G in the vertical direction is about 100 mm to 150 mm. The diameters of the bolt holes 13G, 15G, and 16G are substantially the same as the outer diameters of the bolt 81 and the shaft portions 81A and 85A of the clip 85. Therefore, the bolt 81 and the clip 85 do not move with respect to the door frame 10.

As shown in FIG. 2, the door outer panel 20 is a rectangular panel including an upper peripheral segment 29 which is a first peripheral segment, a lower peripheral segment 32 which is a second peripheral segment opposed to the first peripheral segment, and a front peripheral segment 25F and a rear peripheral segment 25R which are third peripheral segments extending between the first peripheral segment and the second peripheral segment. The upper peripheral segment 29 is located near the belt line 70 of the front door 100. The upper peripheral segment 29, the lower peripheral segment 32, the front peripheral segment 25F, and the rear peripheral segment 25R constitute an outer peripheral portion 35 of the door outer panel 20. As shown in FIGS. 2 to 5, the door outer panel 20 includes an outer flat plate portion 21, a front edge plate portion 23F, a rear edge plate portion 23R, a front plate flange 24F, a rear plate flange 24R, an upper edge plate portion 27, an upper plate flange 28, and a lower plate flange 31.

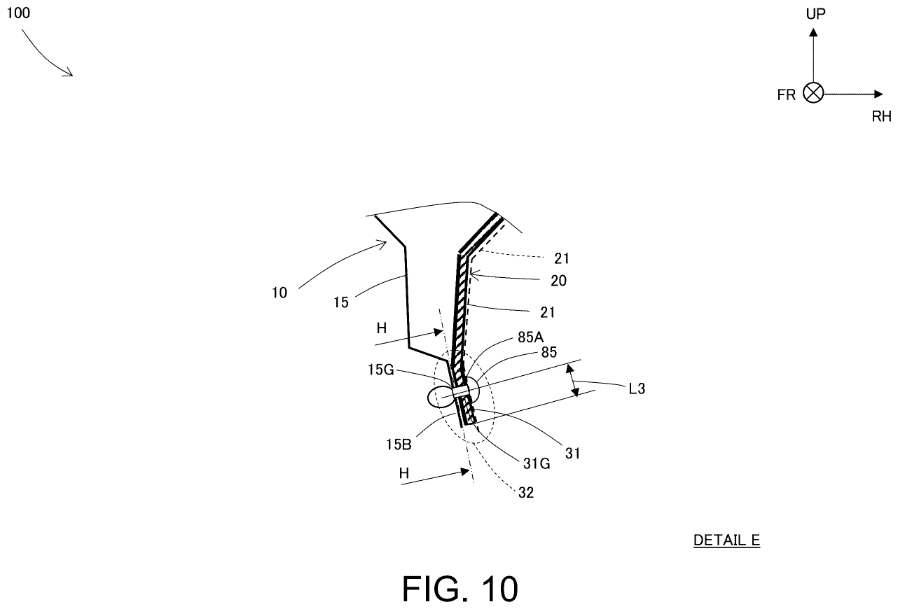

The outer flat plate portion 21 is a plate-shaped portion whose vehicle outer side surface constitutes a design surface of the front door 100. As shown in FIG. 6, the outer flat plate portion 21 includes a front edge portion 22F, a rear edge portion 22R, and an upper edge portion 26. The front edge plate portion 23F is a plate-like portion protruding from the front edge of the outer flat plate portion 21 toward the vehicle inner side (left side). The front plate flange 24F is a plate-like portion that rises rearward from the front edge plate portion 23F toward the interior portion of the door outer panel 20. Similarly, the rear edge plate portion 23R is a plate-like portion protruding toward the vehicle inner side (left side) from the rear edge of the outer flat plate portion 21, and the rear plate flange 24R is a plate-like portion rising forward from the rear edge plate portion 23R. Similarly, as shown in FIG. 8, the upper edge plate portion 27 is a plate-like portion protruding toward the vehicle inner side (left side) from the upper edge of the outer flat plate portion 21, and the upper plate flange 28 is a plate-like portion extending downward from the upper edge plate portion 27. As shown in FIG. 10, the lower plate flange 31 is a plate-like portion extending downward at a lower end portion of the outer flat plate portion 21.

Here, the front edge plate portion 23F, the rear edge plate portion 23R, the front plate flange 24F, the rear plate flange 24R, the upper edge plate portion 27, and the upper plate flange 28 are integrally formed of resin together with the outer flat plate portion 21.

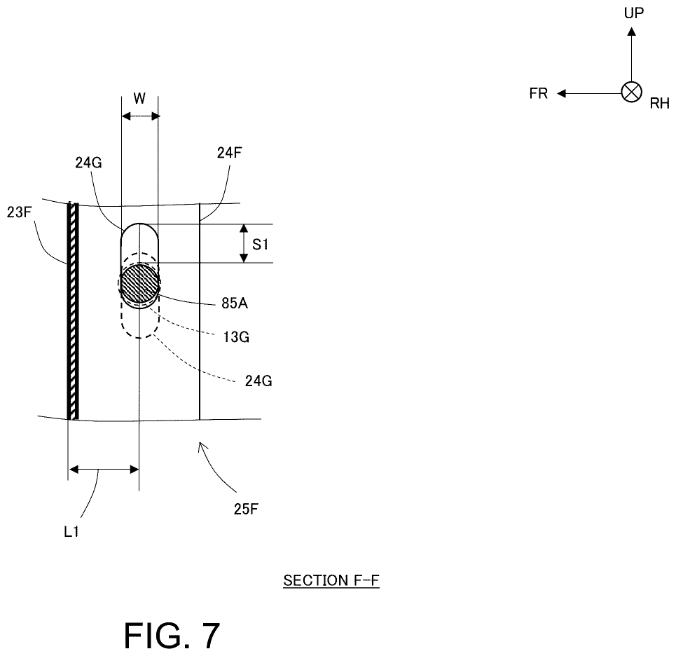

As shown in FIGS. 3, 4, and 6, the front peripheral segment 25F of the door outer panel 20 is attached to the door frame 10 by fastening the front plate flange 24F to the front flange 13F of the door inner panel 11 by a bolt 81 and a nut 82 or a clip 85. Similarly, the rear peripheral segment 25R of the door outer panel 20 is attached to the door frame 10 by fastening the rear plate flange 24R to the rear flange 13R by the bolt 81 and the nut 82 or the clip 85. The front plate flange 24F is provided with an elongated hole 24G through which the clip 85 passes. Similarly to the front plate flange 24F, the rear plate flange 24R is also provided with an elongated hole 24H through which the clip 85 passes. As shown in FIGS. 6 and 7, the length between the center of the elongated hole 24G in the width direction and the front panel end of the door outer panel 20 is L1. In the front door 100, L1 is set to less than 20 mm. The length between the center of the elongated hole 24H in the width direction and the rear panel end of the door outer panel 20 may be L1 or may be a length different from L1 as long as the length is less than 20 mm. Details of the elongated holes 24G and 24H will be described later.

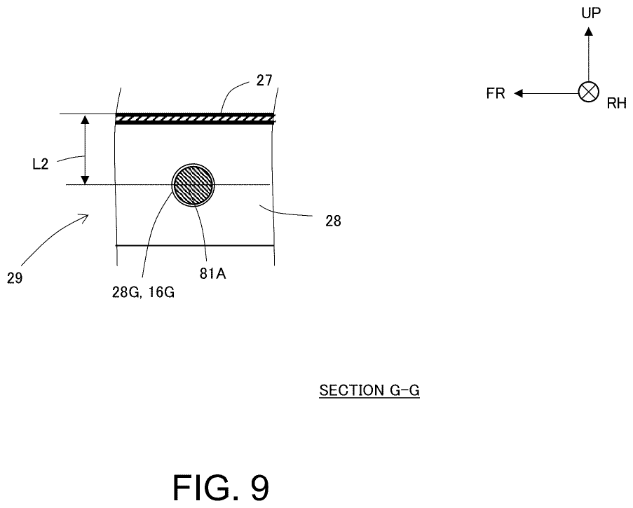

As shown in FIGS. 3, 5, and 8, the upper peripheral segment 29 of the door outer panel 20 is attached to the door frame 10 by fastening the upper plate flange 28 to the upper arm 16A (see FIG. 8) of the outer reinforcement 16 by a bolt 81 and a nut 82 or a clip 85. The upper plate flange 28 is provided with a circular hole 28G through which the bolt 81 or the clip 85 passes. As shown in FIGS. 8 and 9, the length between the circular hole 28G and the upper panel end of the door outer panel 20 is L2. Similar to L1, L2 is set to less than 20 mm. Details of the circular hole 28G will be described later.

As shown in FIGS. 3, 5, 10, and 11, the lower peripheral segment 32 of the door outer panel 20 is attached to the door frame 10 by fastening the lower plate flange 31 to the lower flange 15B of the door inner panel 11 by the clip 85. The lower plate flange 31 is provided with an elongated hole 31G through which the clip 85 passes. Details of the elongated hole 31G will be described later.

As described above, in the door outer panel 20, the outer peripheral portion 35 including the upper peripheral segment 29, the front peripheral segment 25F, the rear peripheral segment 25R, and the lower peripheral segment 32 is attached to the door frame 10. On the other hand, as shown in FIG. 5, the interior portion other than the outer peripheral portion 35 is supported by the lower arm 16B of the outer reinforcement 16, the arm portion 17A of the dent reinforcement 17, and the impact beam 18. The vehicle inner side surface of the interior portion is movable in the plate thickness direction. Specifically, the vehicle inner side surface of the interior portion is connected to the lower arm 16B, the arm portion 17A, and the impact beam 18 via the elastic member 60. The elastic member 60 may be any member as long as the interior portion expands and contracts so as to be movable in the plate thickness direction, and may be, for example, a mastic adhesive.

As shown in FIG. 5, the lower garnish 38 is a U-shaped resin member that covers the lower end portion of the door outer panel 20 and the lower end portion of the door inner panel 11. The clip 85 disposed of the lower peripheral segment 32 is covered by the lower garnish 38.

Next, details of the circular hole 28G and the elongated holes 24G, 24H, and 31G will be described. First, the circular hole 28G will be described. As shown in FIGS. 3 and 9, the diameter of the circular hole 28G of the upper plate flange 28 of the upper peripheral segment 29 is substantially the same as the diameter of the shaft portion 81A of the bolt 81 or the diameter of the shaft portion 85A of the clip 85. Therefore, the upper plate flange 28 does not move with respect to the bolt 81 and the clip 85. As described above, since the bolt 81 and the clip 85 do not move with respect to the upper arm 16A, the upper plate flange 28 does not move with respect to the upper arm 16A. Thus, the upper peripheral segment 29 of the door outer panel 20 is fixed to the door frame 10 by the bolt 81 or the clip 85.

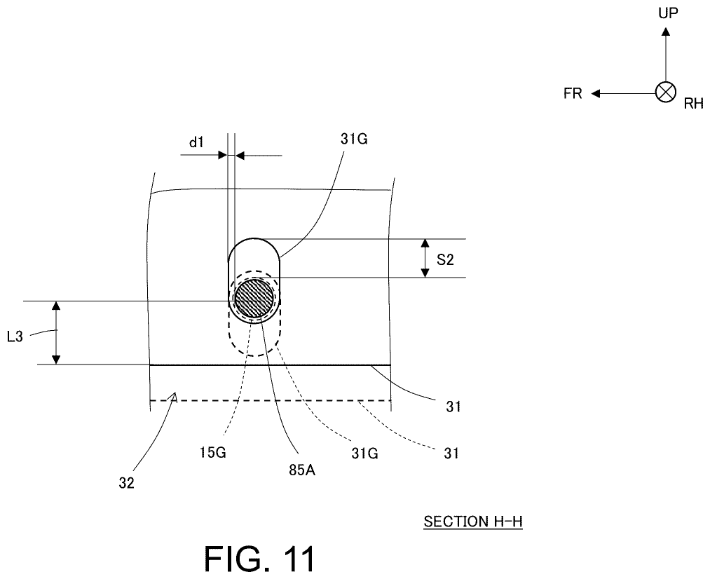

Next, the elongated hole 31G will be described. As shown in FIGS. 3 and 11, the elongated hole 31G is an elongated hole elongated in the vertical direction. The gap between the upper end of the shaft portion 85A of the clip 85 and the upper inner surface of the elongated hole 31G is S2. Due to the elongated hole 31G, the lower plate flange 31 slides downward by S2 with respect to the bolt 81 and the clip 85. Accordingly, the lower peripheral segment 32 of the door outer panel 20 slides downward by S2 with respect to the door frame 10. The elongated hole 31G and the lower plate flange 31 indicated by broken lines in FIG. 11 indicate positions of the elongated hole 31G and the lower plate flange 31 when the door outer panel 20 slides downward.

Here, the length of S2 is shorter than the difference between the amount of thermal expansion in the vertical direction of the door outer panel 20 between the circular hole 28G and the elongated hole 31G and the amount of thermal expansion in the vertical direction of the door frame 10 between the bolt hole 16G and the bolt hole 15G. That is, S2 is shorter than the difference between the thermal expansion amount of the door outer panel 20 and the thermal expansion amount of the door frame 10. S2 can be freely set as long as it is shorter than the difference of the thermal expansion amount, but may be set to, for example, one half of the difference of the thermal expansion amount, or may be set to ⅓ or ⅔ of the difference of the thermal expansion amount.

The gap between the front end of the shaft portion 85A of the clip 85 and the front inner surface of the elongated hole 31G is d1. Therefore, the lower plate flange 31 can slide in the front direction or the rear direction by d1 with respect to the lower flange 15B. Here, d1 can be freely set, but may be set to, for example, about 1 to 2 mm or about 2 to 4 mm.

Next, the elongated holes 24G and 24H will be described. As shown in FIGS. 3 and 7, the elongated hole 24G is long in the vertical direction, and the gap between the upper end of the shaft portion 85A of the clip 85 and the upper inner surface of the elongated hole 24G is S1. Due to the elongated hole 24G, the front plate flange 24F slides downward by S1 with respect to the bolt 81 and the clip 85. Therefore, the front plate flange 24F slides downward by S1 with respect to the front flange 13F. The elongated hole 24H has the same shape as the elongated hole 24G, and the rear plate flange 24R slides downward by S1 with respect to the rear flange 13R. As described above, the front peripheral segment 25F and the rear peripheral segment 25R of the door outer panel 20 slide downward with respect to the door frame 10 similarly to the lower peripheral segment 32. That is, the front peripheral segment 25F and the rear peripheral segment 25R slide in the same direction as the lower peripheral segment 32. An elongated hole 24G indicated by a broken line in FIG. 7 indicates a position of the elongated hole 24G when the door outer panel 20 slides downward.

Here, the length of S1 is set to be equal to or longer than the difference between the thermal expansion amount of the door outer panel 20 and the thermal expansion amount of the door frame 10 so as not to restrict the downward sliding of the lower peripheral segment 32. For example, S1 may be the same length as the difference between the amount of thermal expansion in the vertical direction of the door outer panel 20 between the circular hole 28G and the elongated hole 24G and the amount of thermal expansion in the vertical direction of the door frame 10 between the bolt hole 16G and the bolt hole 13G. In this case, S1 of the lower elongated holes 24G and 24H having a large difference in the amount of thermal expansion is longer than S1 of the upper elongated holes 24G and 24H having a small difference in the amount of thermal expansion. Note that S1 of the upper elongated holes 24G and 24H and S1 of the lower elongated holes 24G and 24H may have the same length. In this case, the length of S1 is set to be equal to or longer than S2 so as not to restrict the downward sliding of the lower peripheral segment 32.

Even when the length of S1 is set to be larger than S2, the downward movement amount of the lower end of the front peripheral segment 25F and the lower end of the rear peripheral segment 25R is the same as the downward movement amount of the lower peripheral segment 23. Therefore, similarly to the lower peripheral segment 32, the lower end of the front peripheral segment 25F and the lower end of the rear peripheral segment 25R slide downward by a length shorter than the difference between the thermal expansion amount of the door outer panel 20 and the thermal expansion amount of the door frame 10, but do not slide downward beyond the difference between the thermal expansion amounts.

The widths W of the elongated holes 24G and 24H are equal to the diameters of the shaft portion 81A of the bolt 81 and the shaft portion 85A of the clip 85. Therefore, the front peripheral segment 25F and the rear peripheral segment 25R of the door outer panel 20 do not move with respect to the door frame 10 in the front-rear direction orthogonal to the up-down direction which is the sliding direction. The front-rear direction is a direction intersecting a boundary line with the fender panel 311 arranged next to the front peripheral segment 25F, and is also a direction intersecting a boundary line with the door outer panel 220 of the rear door 200 arranged next to the rear peripheral segment 25R.

Next, deformation of the door outer panel 20 when the outside air temperature rises will be described. Since the thermal expansion coefficient of the resin is larger than that of the metal, the thermal expansion amount of the door outer panel 20 made of the resin when the outside air temperature rises is larger than the thermal expansion amount of the door frame 10 made of the metal. As described above, the upper peripheral segment 29 is fixed to the door frame 10. On the other hand, the lower peripheral segment 32 slides downward by S2 with respect to the door frame 10. Further, the front peripheral segment 25F and the rear peripheral segment 25R slide downward together with the lower peripheral segment 32. Therefore, when the outside air temperature rises, the door outer panel 20 extends downward starting from the upper peripheral segment 29. As described above, the elongated holes 24G and 31G and the lower plate flange 31 indicated by broken lines in FIGS. 7 and 11 indicate the positions of the elongated holes 24G and 31G and the lower plate flange 31 when the door outer panel 20 slides downward.

Here, the length of S2 is shorter than the difference between the amount of thermal expansion in the vertical direction of the door outer panel 20 between the circular hole 28G and the elongated hole 31G and the amount of thermal expansion in the vertical direction of the door frame 10 between the bolt hole 16G and the bolt hole 15G. Therefore, when the lower peripheral segment 32 slides downward, as shown in FIG. 11, the upper inner surface of the elongated hole 31G abuts against the shaft portion 85A of the clip 85, and cannot slide further. The interior portion between the upper peripheral segment 29 and the lower peripheral segment 32 of the door outer panel 20 is supported by the door frame 10 so that the vehicle inner side surface is movable in the plate thickness direction. Therefore, when the lower peripheral segment 32 cannot slide downward, as shown in FIG. 5, the interior portion between the upper peripheral segment 29 and the lower peripheral segment 32 of the door outer panel 20 deforms so as to bulge toward the vehicle outer side.

The front peripheral segment 25F and the rear peripheral segment 25R of the door outer panel 20 are attached to the door frame 10 so that the door outer panel 20 does not move in the front-rear direction with respect to the door frame 10. The interior portion between the front peripheral segment 25F and the rear peripheral segment 25R of the door outer panel 20 is supported by the door frame 10 so that the vehicle inner side surface is movable in the plate thickness direction. Therefore, as shown in FIG. 4, when the outside air temperature rises, the interior portion between the front peripheral segment 25F and the rear peripheral segment 25R of the door outer panel 20 deforms so as to bulge toward the vehicle outer side.

As described above, when the outside air temperature rises, the lower peripheral segment 32 slides downward and the interior portion deforms so as to bulge toward the vehicle outer side, so that the amount of thermal elongation of the lower peripheral segment 32 in the downward direction can be reduced to improve the appearance, and the thermal stress of the door outer panel 20 can be reduced.

Further, since the front peripheral segment 25F and the rear peripheral segment 25R slide downward together with the lower peripheral segment 32 when the outside air temperature rises, the lower peripheral segment 32 can smoothly extend downward. Thus, the thermal stress of the door outer panel 20 can be reduced.

Further, since the movement of the front peripheral segment 25F in the vehicle front-rear direction is restricted, the amount of forward movement of the front panel end can be reduced. Therefore, the gap between the door outer panel 20 and the fender panel 311 arranged in front of the door outer panel 20 can be reduced, and the appearance can be improved. Similarly, since the rearward movement amount of the rear panel end can be reduced, the gap between the rear door 200 and the door outer panel 220 can be reduced, and the appearance can be improved.

Further, in the door outer panel 20, since the length L1 between the center in the width direction of the elongated hole 24G of the front peripheral segment 25F and the front panel end is set to less than 20 mm, the amount of movement of the front panel end toward the fender panel 311 becomes substantially zero. Accordingly, the gap between the front panel end and the fender panel 311 can be further reduced, and the appearance can be improved. Similarly, the amount of movement of the rear panel end toward the door outer panel 220 of the rear door 200 is also substantially zero. Therefore, the gap between the rear panel end of the door outer panel 20 and the door outer panel 220 of the rear door 200 can be further reduced, and the appearance can be further improved.

Further, since the upper peripheral segment 29 is fixed to the door frame 10, the amount of deformation in the vicinity of the belt line 70 when the outside air temperature rises can be made substantially zero, so that the appearance can be improved.

In addition, since the interior portion other than the outer peripheral portion 35 of the door outer panel 20 is supported by the door frame 10 on the vehicle inner side surface so as to be movable in the plate thickness direction, the interior portion can move in the plate thickness direction to absorb thermal expansion of the door outer panel 20, and fluttering of the door outer panel 20 can be suppressed.

Although the front door 100 has been described above, similarly to the front door 100, the rear door 200 includes a door frame (not shown) made of metal, a door outer panel 220 made of resin, and a lower garnish 238. The outer peripheral portion of the door outer panel 220 is attached to the door frame, and the vehicle inner side surface of the interior portion is supported by the door frame so as to be movable in the plate thickness direction. Similarly to the front door 100, in the rear door 200, since the lower peripheral segment slides downward and the interior portion deforms so as to bulge toward the vehicle outer side when the outside air temperature rises, it is possible to reduce the amount of thermal expansion of the lower peripheral segment in the downward direction, improve the appearance, and reduce the thermal stress of the door outer panel 220. In addition, since the front peripheral segment and the rear peripheral segment do not move in the front-rear direction, it is possible to reduce a gap between the front door 100 and the door outer panel 20 or the quarter panel 312 arranged side by side, and thus it is possible to improve the appearance.

Further, a fender panel 311 made of metal, a quarter panel 312 made of metal, and the like, which are design panels of the body 310, may be attached to the body frame in the same configuration as that of the front door 100. For example, the upper peripheral segment of the fender panel 311 may be fixed to the body frame, the front peripheral segment and the rear peripheral segment of the fender panel 311 may be attached to the body frame so as to slide in the vertical direction without moving in the front-rear direction, and the lower peripheral segment may be attached to the body frame so as to slide in the downward direction. As a result, when the outside air temperature rises, the fender panel 311 expands downward and deforms toward the vehicle outer side, and the movement of the panel end toward the door outer panel 20 of the front door 100 can be suppressed. Accordingly, the gap between the fender panel 311 and the door outer panel 20 can be reduced, and the appearance can be improved. The same applies to the quarter panel 312.

In the above description, the diameter of the shaft portion 81A of the bolt 81 and the widths W of the elongated holes 24G and 24H are set to be the same to restrict the movement of the front peripheral segment 25F and the rear peripheral segment 25R in the front-rear direction. However, the structure for restricting the movement of the front peripheral segment 25F and the rear peripheral segment 25R in the front-rear direction is not limited thereto. For example, the movement of the door outer panel 20 in the front-rear direction may be restricted by providing pins in the door frame 10 and making the widths W of the elongated holes 24G and 24H the same as the diameters of the pins.

In addition, in the above description, the lower peripheral segment 32 of the door outer panel 20 can be slid downward by the elongated holes 24G, 24H, and 31G. However, the structure of allowing the lower peripheral segment 32 to slide downward is not limited thereto. For example, a downward slidable guide may be provided in the lower peripheral segment 32, the front peripheral segment 25F, or the rear peripheral segment 25R. Further, the guide of the lower peripheral segment 32 may be provided with a stopper that regulates the amount of thermal expansion in the downward direction to a predetermined length.

1. A vehicle outer panel assembly comprising:
a frame made of metal, and
an outer panel made of resin, an outer peripheral portion of which is attached to the frame on a vehicle outer side, wherein
the outer peripheral portion is slidable with respect to the frame by a length shorter than a difference between an amount of thermal expansion of the outer panel and an amount of thermal expansion of the frame.

2. The vehicle outer panel assembly according to claim 1, wherein
the outer peripheral portion includes a first outer peripheral segment fixed to the frame and a second outer peripheral segment opposed to the first outer peripheral segment and slidably attached to the frame,
the second outer peripheral segment is slidable by a length shorter than a difference between an amount of thermal expansion of the outer panel between the first outer peripheral segment and the second outer peripheral segment and an amount of thermal expansion of the frame between the first outer peripheral segment and the second outer peripheral segment.

3. The vehicle outer panel assembly according to claim 2, wherein
the outer peripheral portion further includes a third outer peripheral segment extending between the first outer peripheral segment and the second outer peripheral segment,
the third outer peripheral segment is attached to the frame so as to be slidable in the same direction as the second outer peripheral segment with respect to the frame and so as to restrict movement in a direction orthogonal to the sliding direction.

4. The vehicle outer panel assembly according to claim 3, wherein
the third outer peripheral segment is adjacent to a member arranged next to the outer panel,
the direction orthogonal to the sliding direction of the second outer peripheral segment is a direction intersecting a boundary line with the member.

5. The vehicle outer panel assembly according to claim 4, wherein
the frame and the outer panel constitute a side door of a vehicle,
the first outer peripheral segment is an upper outer peripheral segment of the outer panel located in the vicinity of a belt line of the side door,
the second outer peripheral segment is a lower outer peripheral segment of the outer panel,
the third outer peripheral segment is a front outer peripheral segment or a rear outer peripheral segment of the outer panel.

6. The vehicle outer panel assembly according to claim 1, wherein
the outer panel includes an interior portion other than the outer peripheral portion,
a vehicle inner side surface of the interior portion is supported by the frame so as to be movable in the plate thickness direction.

7. The vehicle outer panel assembly according to claim 2, wherein
the outer panel includes an interior portion other than the outer peripheral portion,
a vehicle inner side surface of the interior portion is supported by the frame so as to be movable in the plate thickness direction.

8. The vehicle outer panel assembly according to claim 3, wherein
the outer panel includes an interior portion other than the outer peripheral portion,
a vehicle inner side surface of the interior portion is supported by the frame so as to be movable in the plate thickness direction.

9. The vehicle outer panel assembly according to claim 4, wherein
the outer panel includes an interior portion other than the outer peripheral portion,
a vehicle inner side surface of the interior portion is supported by the frame so as to be movable in the plate thickness direction.

10. The vehicle outer panel assembly according to claim 5, wherein
the outer panel includes an interior portion other than the outer peripheral portion,
a vehicle inner side surface of the interior portion is supported by the frame so as to be movable in the plate thickness direction.
